(19) United States
(12) Patent Application Publication
(10) Pub. No.: US 2015/0124700 A1
(43) Pub. Date: May 7, 2015

(54) METHOD OF ASSISTING USER EQUIPMENT IN RECEIVING BROADCAST INFORMATION OF PICO ENB

(71) Applicant: Alcatel Lucent, Boulogne Billancourt (FR)

(72) Inventors: Qi Jiang, Shanghai (CN); Zheng Liu, Shanghai (CN)

(73) Assignee: Alcatel Lucent, Boulogne Billancourt (FR)

(21) Appl. No.: 14/400,016

(22) PCT Filed: Apr. 22, 2013
(86) PCT No.: PCT/IB2013/001148

§ 371 Date: Nov. 10, 2014

(30) Foreign Application Priority Data
May 10, 2012 (CN) 201210144334.7

(51) Int. Cl. H04W 48/16

(52) U.S. Cl. CPC H04W 48/16
USPC 370/328

(57) ABSTRACT

The invention provides a method, in a communication System, of assisting a user equipment in a cell range expansion of a pico cell in receiving broadcast information from a pico eNB. According to an embodiment of the invention, a macro eNB or the pico eNB sends an assisting signaling including the broadcast information of the pico cell and an identifier of the pico cell corresponding to the broadcast information to the user equipment which will move into the cell range expansion of the pico cell so that the user equipment receives the broadcast information smoothly from the pico eNB after moving into the cell range expansion of the pico cell. And the macro eNB or the pico eNB sends and updates the broadcast information over a specific resource so that the user equipment satisfies reception robustness.

### FIELD OF THE INVENTION

The present disclosure relates to a communication system and particularly to a method, in a communication system, of assisting a user equipment in a cell range expansion of a pico cell in receiving broadcast information from a pico eNB.

### BACKGROUND OF THE INVENTION

At present in the 3GPP Rel-1, further enhancement on inter-cell interference coordination has gained particular attention. The following key issue is also involved, that is, how a user equipment operates well in a cell range expansion of a pico cell when the user equipment fails to detect some important broadcast information of the pico cell.

The size of the cell range expansion is associated with the magnitude of a biased value. For example, the biased value can be set to 5 dB, 9 dB and etc. A large number of user equipments can be served by the pico cell through setting the biased value for an inter-cell handover and a cell selection. Thus the capacity of users is increased by the pico cell, and only some central services are served by a macro cell.

Unlike a legacy cell selection and/or access scheme, the biased value is introduced when the user equipment accesses to the pico cell with the cell range expansion, that is, the user equipment will access the pico cell when the power, signal to noise ratio and etc., of a signal received by the user equipment from the pico cell plus biased value is above the power, signal to noise ratio and etc., of a signal from the macro cell.

Thus such a problem is incurred that the power of the signal from the pico cell is below that of the macro cell despite that the user equipment has accessed to the pico cell. With the increasing biased value, the user equipment in the cell range expansion will be unable to receive broadcast information correctly from a pico eNB, e.g., a master information block, a system information block-x, paging information and etc.

As a result of this, the user equipment in the cell range expansion can not receive the broadcast information correctly from the pico eNB and consequently has to be switched back to the macro cell, thus contradicting the reason for which the cell range expansion was introduced.

### SUMMARY OF THE INVENTION

Apparently the problem present in the prior art lies in that the user equipment can not acquire the broadcast information from the pico eNB and thus can not be scheduled when moving to the cell range expansion of the pico cell. That is, the user equipment, which satisfied a handover request, can “see” the pico cell but can not receive any broadcast information from the pico eNB and consequently has to be switched out of the pico cell again.

Thus in view of the problem present in the prior art, according to a first aspect of the invention a method, in a macro eNB of a communication system, of assisting a user equipment in a cell range expansion of a pico cell in receiving broadcast information from a pico eNB is proposed, wherein a coverage area of the macro eNB includes at least one region served by the pico eNB, the region served by the pico eNB includes the cell range expansion, and the macro eNB shares the broadcast information of the pico eNB, and the method includes the steps of: a. determining the user equipment which will move from a macro cell into the cell range expansion of the pico cell; and b. sending a first assisting signaling to the determined user equipment in a predetermined transmission mode and a predetermined transmission mode over a predetermined time and frequency resource, the first assisting signaling including the broadcast information of the pico eNB shared by the macro eNB and an identifier of the pico cell corresponding to the broadcast information.

According to a preferred embodiment of the invention, the step a further includes: determining that the user equipment will move from the macro cell into the cell range expansion of the pico cell upon reception of a sequence number of an event trigger report from the user equipment, wherein the event trigger report indicates that a signal quality of the macro cell is below an absolute threshold, a signal quality of the pico cell plus a biased value is above the signal quality of the macro cell or the signal quality of the pico cell plus the biased value is above an absolute threshold.

Here the user equipment can utilize the event A2 (i.e., the channel measurement quality of a current cell being below an absolute threshold), the event A3 (i.e., the channel measurement quality of an adjacent cell plus a biased value being above that of the current cell) and the event A4 (i.e., the channel measurement quality of the adjacent cell (including the biased value) being above the absolute threshold) in the event trigger report criterion defined in the LTE, where setting of the biased value and setting of the absolute value can be generated with the coordination of the macro cell and the pico cell or decided at the network side.

Upon a event is triggered, the user equipment sends the sequence number of a corresponding event trigger report to the macro eNB, so that the eNB can determine from the sequence number of the report that the user equipment will move from the macro cell into the cell range expansion of the pico cell.

According to a preferred embodiment of the invention, the step a further includes: receiving a predetermined quality parameter from the user equipment, and determining that the user equipment will move from the macro cell into the cell range expansion of the pico cell when the predetermined quality parameter is below a predetermined threshold, where the predetermined parameter includes any one of a received signal power, a received signal quality and a modulation and coding scheme level. For example, the user equipment sends a parameter to the macro eNB, and the eNB can compare the parameter with a predetermined threshold and thus determine whether the user equipment will move from the macro cell into the cell range expansion of the pico cell. For example, the threshold can be determined with respect to a transmission requirement of a physical broadcast channel, SIB-x, paging information and etc.

For example, specifically, for different code rate and modulation, a modulation and coding scheme (MCS) has 27 levels. The user equipment will report its appropriate MCS selection when the user equipment is scheduled. The use equipment will report a QPSK scheme if it judges a channel is poor. In this case, the macro eNB can implicitly judge its channel is poor and determine that the user equipment will move from the macro cell into the cell range expansion of the pico cell.

According to a preferred embodiment, the predetermined time and frequency resource enables the user equipment to satisfy reception robustness.

According to a preferred embodiment, the predetermined transmission scheme includes a repeated transmission scheme and a spatial diversity scheme. Thus transmission robustness is further ensured and a coverage area of the assisting signaling is extended. Those skilled in the art shall appreciate that any other similar transmission scheme can be used here to satisfy transmission robustness.

According to a preferred embodiment, the predetermined transmission mode includes a user-specific transmission mode and a user group-specific transmission mode. Since the sent assisting signaling is same for all the user equipments, the user group-specific transmission mode can be adopted, that is, only one block of resource is required over a Physical Downlink Control Channel (PDCCH) or an enhanced Physical Downlink Control Channel (EPDCCH) to support the transmission of the broadcast information of all the user equipments. Thereby, the efficiency is improved and resources are saved. On the other hand, in the case that the user-specific transmission mode is selected, resources over the PDCCH or the EPDCCH can be allocated separately for the respective user equipments so that the user equipments can use the resources over the PDCCH or the EPDCCH more flexibly. For example, the user equipment 1 can be scheduled over a resource appropriate for the user equipment 1, and the user equipment 2 can be scheduled over another block of resource appropriate for the user equipment 2, thus improving the flexibility and the freedom.

According to a second aspect of the invention, a method, in a pico eNB of a communication system, of assisting a user equipment in a cell range expansion of a pico cell in receiving broadcast information from the pico eNB is proposed, wherein a coverage area of a macro eNB includes at least one region served by the pico eNB, the region served by the pico eNB includes the cell range expansion, and the macro eNB shares the broadcast information of the pico eNB, and the method includes the steps of: g. sending a first control signaling to the user equipment moving from a macro cell into the cell range expansion of the pico cell, the first control signaling indicating that the pico eNB will send the broadcast information to the user equipment over a time and frequency resource of a protected subframe corresponding to an almost blank subframe of the macro eNB; and h. sending the broadcast information over the time and frequency resource of the protected subframe.

According to a preferred embodiment of the invention, the time and frequency resource of the protected subframe enables the user equipment to satisfy reception robustness.

According to a preferred embodiment of the invention, the step h further includes: updating the user equipment in the cell range expansion and sending the broadcast information to the updated user equipment over the time and frequency resource of the protected subframe.

Here the pico eNB can monitor and acquire that user equipments are moving into and out of the cell range expansion of the pico cell and further update the user equipments in the cell range expansion to thereby update or send the broadcast information for those user equipments over time and frequency resources of the protected subframe.

According to a third aspect of the invention, a method, in a user equipment of a communication system, of assisting a user equipment in a cell range expansion of a pico cell in receiving broadcast information from a pico eNB is proposed, wherein a coverage area of a macro eNB includes at least one region served by the pico eNB, the region served by the pico eNB includes the cell range expansion, and the macro eNB shares the broadcast information of the pico eNB, and the method includes the steps of: i. sending a sequence number of an event trigger report or a predetermined quality parameter to the macro eNB; ii. receiving a first assisting signaling from the macro eNB over a predetermined time and frequency resource, the first assisting signaling including the broadcast information, of the pico eNB, shared by the macro eNB and an identifier of the pico cell corresponding to the broadcast information; iii. receiving a first control signaling from the pico cell when the user equipment moves from a macro cell into the cell range expansion of the pico cell, the first control signaling indicating that the pico eNB will send the broadcast information to the user equipment over a time and frequency resource of a protected subframe corresponding to an almost blank subframe of the macro eNB; and iv. receiving the broadcast information from the pico eNB over the time and frequency resource of the protected subframe corresponding to the almost blank subframe of the macro eNB.

According to a preferred embodiment, the predetermined time and frequency resource and the time and frequency resource of the protected subframe respectively enable the determined user equipment to satisfy reception robustness.

According to a fourth embodiment of the invention, a method, in a pico eNB of a communication system, of assisting a user equipment in a cell range expansion of a pico cell in receiving broadcast information from the pico eNB is proposed, wherein a coverage area of a macro eNB includes at least one region served by the pico eNB, and the region served by the pico eNB includes the cell range expansion, and the method includes the steps of: A. determining the user equipment which will move from the pico cell into the cell range expansion of the pico cell; B. sending a second assisting signaling to the determined user equipment in a predetermined transmission scheme and a predetermined transmission mode over a time and frequency resource of a protected subframe corresponding to an almost blank subframe of the macro eNB, the second assisting signaling including the broadcast information of the pico eNB and an identifier of the pico cell corresponding to the broadcast information; C. sending a second control signaling to the user equipment moving from the pico cell to the cell range expansion of the pico cell, the second control signaling indicating that the pico eNB will send the broadcast information to the user equipment over the time and frequency resource of the protected subframe corresponding to the almost blank subframe of the macro eNB; and D. sending the broadcast information over the time and frequency resource of the protected subframe.

According to a preferred embodiment of the invention, the step A further includes: determining that the user equipment will move from the pico cell into the cell range expansion of the pico cell upon reception of a sequence number of an event trigger report from the user equipment, wherein the event trigger report indicates that a signal quality of the pico cell is below an absolute threshold, a signal quality of a macro cell plus a biased value is above the signal quality of the pico cell or the signal quality of the macro cell plus the biased value is above an absolute threshold.

Here the user equipment can utilize the event A2, the event A3 and the event A4 in the event trigger report criterion defined in the LTE and send the sequence number of a corresponding event trigger report to the macro eNB when the event is trigged, so that the eNB can determine from the sequence number of the report that the user equipment will move from the macro cell into the cell range expansion of the pico cell.

According to a preferred embodiment of the invention, the step A further includes: receiving a predetermined quality parameter from the user equipment, and determining that the user equipment will move from the pico cell into the cell range expansion of the pico cell when the predetermined quality parameter is below a predetermined threshold.

According to a preferred embodiment of the invention, the step D further includes: updating the user equipment in the cell range expansion and sending the broadcast information to the updated user equipment over the time and frequency resource of the protected subframe.

According to a fifth embodiment of the invention, a method, in a user equipment of a communication system, of assisting a user equipment in a cell range expansion of a pico cell in receiving broadcast information from a pico eNB is proposed, wherein a coverage area of a macro eNB includes at least one region served by the pico eNB, and the region served by the pico eNB includes the cell range expansion, and the method includes the steps of: X1. sending a sequence number of an event trigger report or a predetermined quality parameter to the pico eNB; X2. receiving a second assisting signaling from the pico eNB over a time and frequency resource of a protected subframe corresponding to an almost blank subframe of the macro eNB, the second assisting signaling including the broadcast information of the pico eNB and an identifier of the pico cell corresponding to the broadcast information; X3. receiving a second control signaling from the pico cell when the user equipment moves from the pico cell into the cell range expansion of the pico cell, the second control signaling indicating that the pico eNB will send the broadcast information to the user equipment over the time and frequency resource of the protected subframe corresponding to the almost blank subframe of the macro eNB; and X4. receiving the broadcast information from the pico eNB over the time and frequency resource of the protected subframe corresponding to the almost blank subframe of the macro eNB.

Thus with the preferred technical solution of the invention, the assisting signaling including the broadcast information of the pico cell can be sent in advance to the user equipment moving towards the cell range expansion of the pico cell, so that the user equipment is truly switched to the pico cell after moving in the cell range expansion of the pico cell. On the other hand, by sending and updating the broadcast information over the specific resource, the reception robustness of the user equipment is satisfied.

Specifically, since the broadcast information is updated periodically instead of being present in each frame. For example, a master information block is updated once every 40 ms, a system information block-x is updated once every 80 ms, and paging information is updated once every 160 ms, thus it is only necessary to ensure those broadcast information of pico eNB to be updated or sent to the user equipment before the user equipment moves into the cell range expansion so that the user equipment can make use of the still valid broadcast information for a handover even after moving into the cell range expansion. With a resource with a relatively high signal to noise ratio, for example, some time and frequency resource of the protected subframe corresponding to the almost blank subframe of the macro eNB, the pico eNB can send the broadcast information to the user equipment after the user equipment moves into the cell range expansion.

For example, for the broadcast information including a master information block, a system information block-x and paging information, the broadcast information in the assisting signaling received by the user equipment before moving into the cell range expansion is valid throughout succeeding 40 ms, so the user equipment can be switched smoothly into the pico cell as long as in the succeeding 40 ms the pico eNB selects an appropriate time and frequency resource of the protected subframe corresponding to the almost blank subframe of the macro eNB to update the broadcast information.

### BRIEF DESCRIPTION OF DRAWINGS

Other features, objects and advantages of the invention will become more apparent upon review of the following detailed description of non-limiting embodiments taken with reference to the drawings in which:

FIG. 1 illustrates a schematic diagram of a cellular network according to an embodiment of the invention;

FIG. 2 illustrates a flow chart of a method of assisting a user equipment in a cell range expansion of a pico cell in receiving broadcast information from a pico eNB according to an embodiment of the invention;

FIG. 3 illustrates a schematic diagram of a cellular network according to another embodiment of the invention; and

FIG. 4 illustrates a flow chart of a method of assisting a user equipment in a cell range expansion of a pico cell in receiving broadcast information from a pico eNB according to another embodiment of the invention.

Identical or like reference numerals denote identical or like components or features throughout the different figures in the drawings.

### DETAILED DESCRIPTION OF EMBODIMENTS

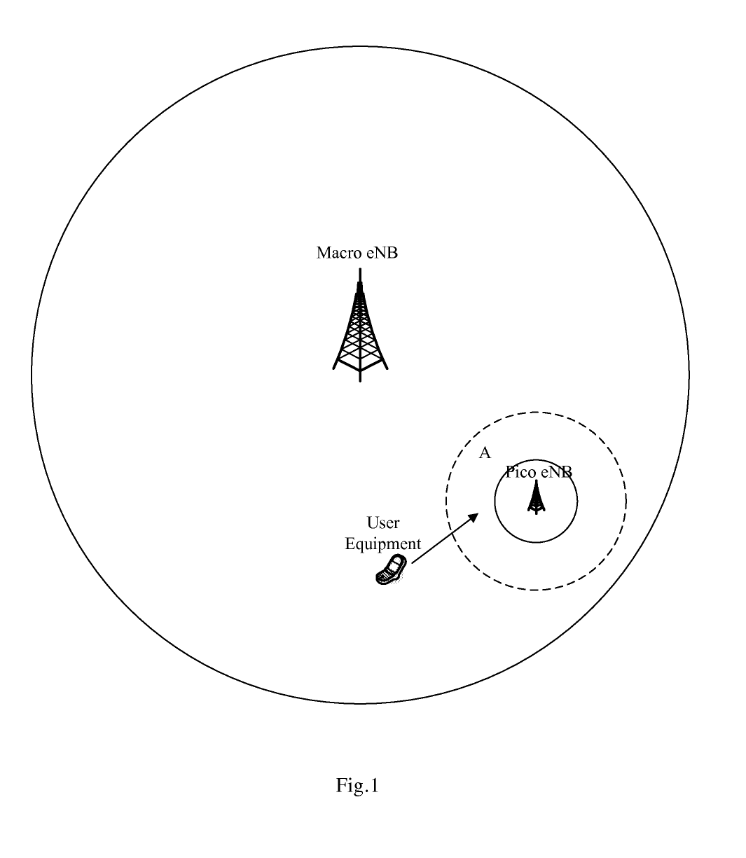

FIG. 1 illustrates a schematic diagram of a cellular network according to an embodiment of the invention.

As illustrated in FIG. 1, a coverage area of a macro eNB includes a region served by a pico eNB, and the region served by the pico eNB includes a cell range expansion (the region A between the dotted-line circle and the solid-line circle). However those skilled in the art shall appreciate that the coverage area of the macro eNB can include a plurality of pico eNBs and can include regions served by the respective different pico eNBs and thus further include a plurality of cell range expansions.

Moreover as illustrated in FIG. 1, a user equipment is moving from a macro cell towards the cell range expansion of a pico cell.

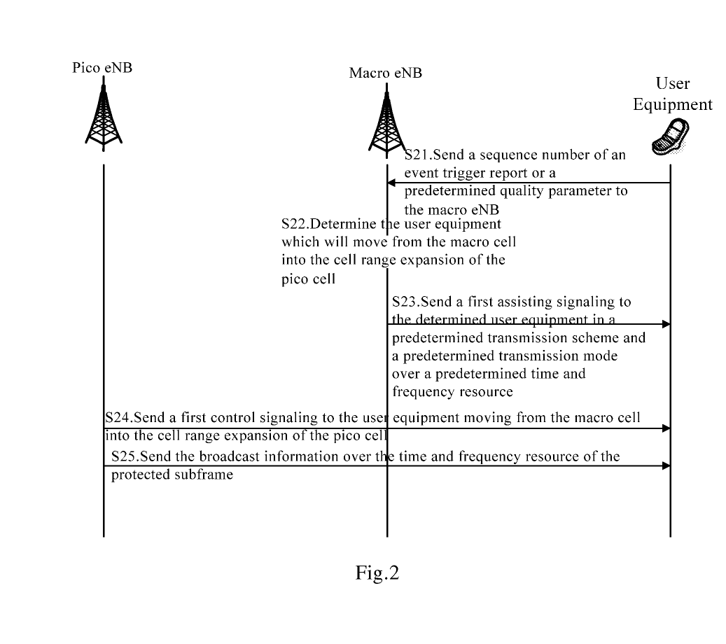

Together with FIG. 1, FIG. 2 illustrates a flow chart of a method of assisting a user equipment in a cell range expansion of a pico cell in receiving broadcast information from a pico eNB according to an embodiment of the invention.

In the step S21, the user equipment sends a sequence number of an event trigger report or a predetermined quality parameter to the macro eNB. In the step S22, the macro eNB determines the user equipment which will move from the macro cell into the cell range expansion of the pico cell.

Specifically in the case of sending the sequence number of the event trigger report, for example, the user equipment can utilize the event A2, the event A3 and the event A4 defined in the LTE and report a sequence number corresponding to the event to the macro eNB when the event is triggered. At this time the macro eNB will determine that the user equipment will move from the macro cell into the cell range expansion of the pico cell.

Alternatively, the user equipment can measure some predetermined quality parameter periodically, e.g., a received signal power, a received signal quality and a modulation and coding scheme level, and report the predetermined quality parameter to the macro eNB. The macro eNB can compare the parameter with a predetermined threshold to thereby determine whether the user equipment will move from the macro cell into the cell range expansion of the pico cell. For example, the threshold can be determined with respect to a transmission requirement of a physical broadcast channel, SIB-x, paging information, etc.

In the step S23, the macro eNB sends a first assisting signaling to the determined user equipment in a predetermined transmission scheme and a predetermined transmission mode over a predetermined time and frequency resource, the first assisting signaling including the broadcast information of the pico eNB shared by the macro eNB and an identifier of the pico cell corresponding to the broadcast information. Thus the user equipment can acquire the broadcast information of the pico eNB from the first assisting signaling and know from the identifier of the pico cell to which pico cell the broadcast information corresponds.

For example, specifically the macro eNB can send the first assisting signaling including the broadcast information of the pico eNB to the user equipment over a Physical Downlink Shared Channel (PDSCH), schedule the user equipment over a PDCCH and inform the user equipment on which Physical Resource Block (PRB) pair the assisting signaling is located. This process can be performed as predefined, for example.

Preferably, the predetermined time and frequency resource enables the determined user equipment to satisfy reception robustness. For example, the macro eNB can select a time and frequency resource with a better channel quality indicator to send the first assisting signaling.

Moreover, correct reception of the assisting signaling by the user equipment can further be ensured in a repeated transmission scheme and a spatial diversity scheme. On the other hand, the predetermined transmission mode can include a user-specific transmission mode and a user group-specific transmission mode.

Preferably, the assisting signaling can be performed in RRC signaling or higher layer signaling. An example of the assisting signaling, BroadCastlnfoAssist, illustrated in a PhysicalConfigDedicated information element, includes an MIB and SIB-1 by way of an example. Moreover, the identifier, physCellId, of the pico cell is embedded in the assisting signaling so that the user equipment can match the assisting information correctly to the pico cell.

### PhysicalConfigDedicated Information Element

| | |
|---|---|
| PhysicalConfigDedicatedSCell-r10 ::= | SEQUENCE { |

-- DL configuration as well as configuration applicable for DL and UL

| | |
|---|---|
| nonUL-Configuration-r10 | SEQUENCE { |

| | |
|---|---|
| antennaInfo-r10 | AntennaInfoDedicated-r10 OPTIONAL, -- Need ON |

| | | |
|---|---|---|
| crossCarrierSchedulingConfig-r10 | CrossCarrierSchedulingConfig-r10 OPTIONAL, | -- Need ON |

| | | | |
|---|---|---|---|
| csi-RS-Config-r10 | CSI-RS-Config-r10 | OPTIONAL, | -- Need ON |

| | | | |
|---|---|---|---|
| pdsch-ConfigDedicated-r10 | PDSCH-ConfigDedicated | OPTIONAL | -- Need ON |

| | | | |
|---|---|---|---|
| } | | OPTIONAL, | -- Cond SCellAdd |
| -- UL configuration | | | |
| ul-Configuration-r10 | SEQUENCE { | | |

| | | | |
|---|---|---|---|
| antennaInfoUL-r10 | AntennaInfoUL-r10 | OPTIONAL, | -- Need ON |

| | | |
|---|---|---|
| pusch-ConfigDedicatedSCell-r10 | PUSCH-ConfigDedicatedSCell-r10OPTIONAL, | -- Need ON |
| uplinkPowerControlDedicatedSCell-r10 | UplinkPowerControlDedicatedSCell-r10 OPTIONAL, | -- Need ON |
| cqi-ReportConfigSCell-r10 | CQI-ReportConfigSCell-r10 OPTIONAL, | -- Need ON |
| soundingRS-UL-ConfigDedicated-r10 | SoundingRS-UL-ConfigDedicated OPTIONAL, | -- Need ON |
| soundingRS-UL-ConfigDedicated-v1020 | | |

| | |
|---|---|
| SoundingRS-UL-ConfigDedicated-v1020OPTIONAL, | -- Need ON |

soundingRS-UL-ConfigDedicatedAperiodic-r10

| | | |
|---|---|---|
| SoundingRS-UL-ConfigDedicatedAperiodic-r10 | OPTIONAL | -- Need ON |

| | |
|---|---|
| } | OPTIONAL,-- Cond CommonUL |
| ... | |
| ic-Assistance ::= SEQUENCE { | |

| | |
|---|---|
| BroadCastInfoAssist | SEQUENCE { |

| | |
|---|---|
| physCellId | physCellId |

| | |
|---|---|
| MasterInformationBlock ::= | SEQUENCE { |
| ... | |
| } | |
| SystemInformationBlockType1 ::= | SEQUENCE { |
| ... | |
| } | |
| } | |
| } | |
| -- ASN1STOP | |

In the step S24, the pico eNB sends a first control signaling to the user equipment moving from the macro cell into the cell range expansion of the pico cell, the first control signaling indicating that the pico eNB will send the broadcast information to the user equipment over a time and frequency resource of a protected subframe corresponding to an almost blank subframe of the macro eNB.

Since the macro eNB sends no or little information in the almost blank subframe, mutual interference can be avoided if the pico eNB sends the broadcast information to the user equipment over the resource in the protected subframe corresponding to the almost blank subframe of the macro eNB, thus providing the user equipment with good reception robustness.

Preferably, the pico eNB can select a resource with a better channel quality indicator in the protected subframe to send the broadcast information.

The process of performing the step S24 can be performed, for example, before or during a handover from the macro cell to the pico cell. Thus the user equipment can receive the scheduling of the pico cell and be ready to receive the broadcast information from the pico eNB over those resources.

In the step S25, the pico eNB sends its broadcast information over the time and frequency resource of the protected subframe. Preferably, the pico eNB can select 40 ms over a fixed resource as an update period to update or send the broadcast information by considering a minimum update period of the broadcast information such as MIB, SIB-x and paging information, etc. For example, the fixed resource can be a resource with a better channel quality indicator among time and frequency resources of the protected subframe.

Preferably, in this step, the pico eNB can further monitor and acquire user equipments are moving into and out of the cell range expansion of the pico cell and further update the user equipments in the cell range expansion to thereby send the broadcast information to those user equipments over the time and frequency resources of the protected subframe.

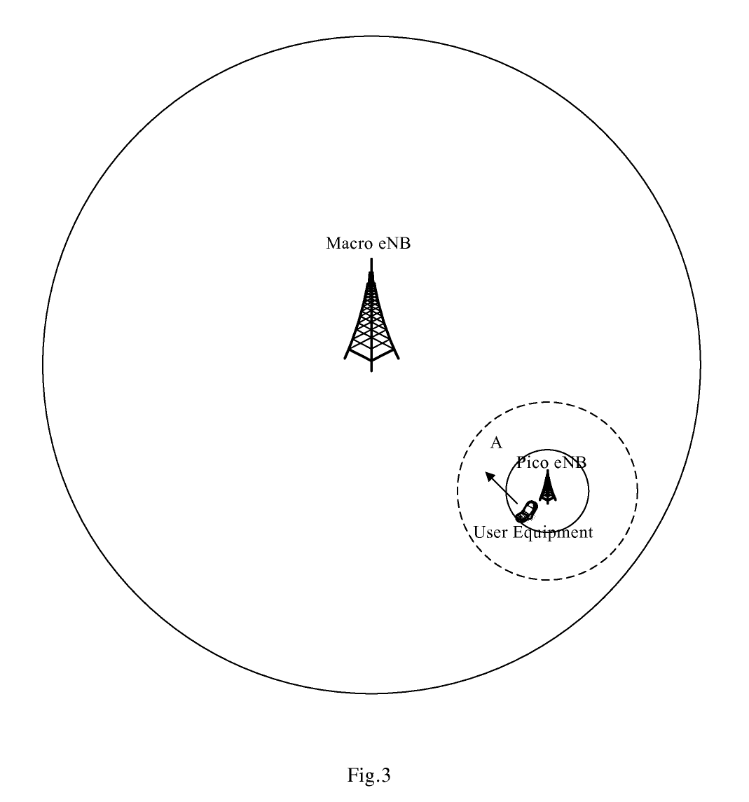

FIG. 3 illustrates a schematic diagram of a cellular network according to another embodiment of the invention.

As illustrated in FIG. 3, a coverage area of a macro eNB includes a region served by a pico eNB. The region served by the pico eNB includes a cell range expansion (the region A between the dotted-line circle and the solid-line circle). However those skilled in the art shall appreciate that the coverage area of the macro eNB can include a plurality of pico eNBs and can include regions served by the respective different pico eNBs and thus further include a plurality of cell range expansions.

Moreover as illustrated in FIG. 3, a user equipment is moving from a pico cell to the cell range expansion of the pico cell.

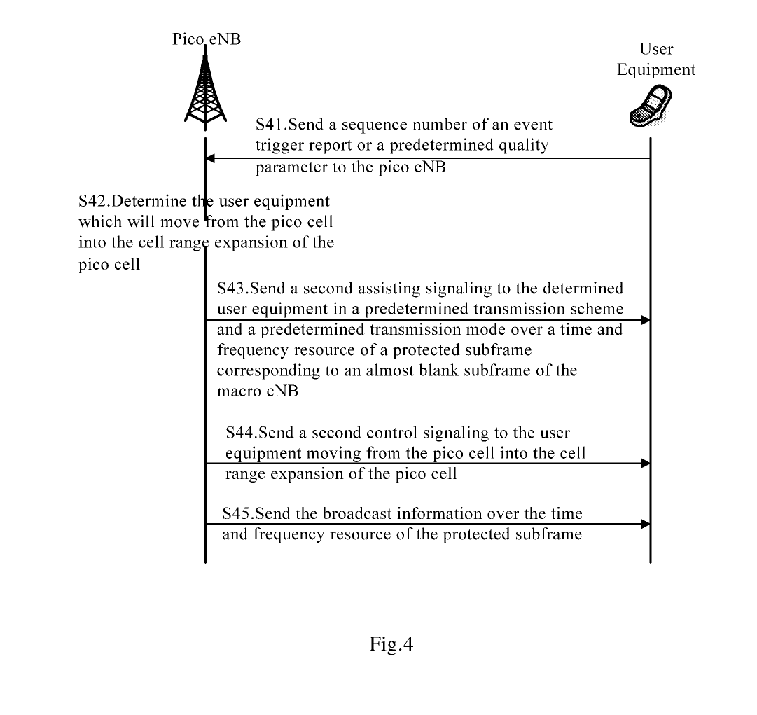

Together with FIG. 3, FIG. 4 illustrates a flow chart of a method of assisting a user equipment in a cell range expansion of a pico cell in receiving broadcast information from a pico eNB according to another embodiment of the invention.

In the step S41, the user equipment sends a sequence number of an event trigger report or a predetermined quality parameter to the pico eNB. In the step S42, the pico eNB determines the user equipment which will move from the pico cell into the cell range expansion of the pico cell.

Specifically in the case of sending the sequence number of the event trigger report, for example, the user equipment can utilize the event A2, the event A3 and the event A4 defined in the LTE and report a sequence number corresponding to the event to the pico eNB when the event is triggered. At this time the pico eNB will determine that the user equipment will move from the pico cell into the cell range expansion of the pico cell.

Alternatively, the user equipment can measure some predetermined quality parameter periodically, e.g., a received signal power, a received signal quality and a modulation and coding scheme level, and report the predetermined quality parameter to the pico eNB. The pico eNB can compare the parameter with a predetermined threshold to thereby determine whether the user equipment will move from the pico cell into the cell range expansion of the pico cell. For example, the threshold can be determined with respect to a transmission requirement of a physical broadcast channel, SIB-x, paging information, etc.

In the step S43, the pico eNB sends a second assisting signaling to the determined user equipment in a predetermined transmission scheme and a predetermined transmission mode over a time and frequency resource of a protected subframe corresponding to an almost blank subframe of the macro eNB, the second assisting signaling including the broadcast information of the pico eNB and an identifier of the pico cell corresponding to the broadcast information. Thus the user equipment can acquire the broadcast information of the pico eNB from the second assisting signaling and know from the identifier of the pico cell to which pico cell the broadcast information corresponds.

For example, specifically the pico eNB can send the second assisting signaling including the broadcast information of the pico eNB to the user equipment over a Physical Downlink Shared Channel (PDSCH), schedule the user equipment over a PDCCH and inform the user equipment on which Physical Resource Block (PRB) pair the assisting signaling is located. This can be performed as predefined, for example.

Since the macro eNB sends no or little information in the almost blank subframe, mutual interference can be avoided if the pico eNB sends the second assisting signaling over the resource in the protected subframe corresponding to the almost blank subframe of the macro eNB, thus providing the user equipment with good reception robustness.

Preferably, the pico eNB can select a resource with a better channel quality indicator in the protected subframe to send the assisting signaling.

Moreover, correct reception of the assisting signaling by the user equipment can further be ensured in a repeated transmission scheme and a spatial diversity scheme. On the other hand, the predetermined transmission mode can include a user-specific transmission mode and a user group-specific transmission mode. Furthermore, the second assisting signaling is realized similarly to the foregoing first assisting signaling, and a detailed description thereof will not be repeated here.

In the step S44, the pico eNB sends a second control signaling to the user equipment moving from the pico cell into the cell range expansion of the pico cell, the first control signaling indicating that the pico eNB will send the broadcast information to the user equipment over the time and frequency resource of the protected subframe corresponding to the almost blank subframe of the macro eNB. This process can be performed, for example, before, during or after the movement of the user equipment into the cell range expansion. Thus the user equipment, which has moved into the cell range expansion, can receive the scheduling by the pico cell and be ready to receive the broadcast information from the pico eNB over those resources.

Since the macro eNB sends no or little information in the almost blank subframe, mutual interference can be avoided if the pico eNB sends the broadcast information to the user equipment over the resource in the protected subframe corresponding to the almost blank subframe of the macro eNB, thus providing the user equipment with good reception robustness.

Preferably the pico eNB can select a resource with a better channel quality indicator in the protected subframe to send the broadcast information.

In the step S45, the pico eNB sends its broadcast information over the time and frequency resource of the protected subframe. Preferably the pico eNB can select 40 ms over a fixed resource as an update period to update or send the broadcast information by considering a minimum update period of the broadcast information such as MIB, SIB-x and paging information, etc. For example, the fixed resource can be a resource with a better channel quality indicator among time and frequency resources of the protected subframe.

Preferably in this step, the pico eNB can further monitor and acquire user equipments are moving into and out of the cell range expansion of the pico cell and further update the user equipments in the cell range expansion to thereby send the broadcast information to those user equipments over the time and frequency resources of the protected subframe.

Alternatively, in order to enable the user equipment in the cell range expansion to receive the broadcast information of the pico eNB correctly, starting sub-frames of the macro eNB and the pico eNB can be displaced from each other so that the locations of the sub-frames, that the macro eNB and the pico eNB use to send the broadcast information respectively, offset from each other.

Those skilled in the art shall appreciate that the foregoing embodiments are illustrative but not limiting. Different technical features appearing in different embodiments can be combined to advantage. Those skilled in the art can appreciate and make other variant embodiments of the disclosed embodiments upon review of the drawings, the description and the claims. In the claims, the term “comprising” will not preclude another device(s) or step(s); the definite article “a” or “an” will not preclude plural; and the terms “first”, “second”, etc., are intended to designate a name but not to suggest any specific order. Any reference numerals shall not be construed as limiting the claimed scope. Functions of a plurality of elements appearing in a claim can be performed by a single element. Some technical features appearing in different dependent claims will not suggest that these technical features can not be combined to advantage.

1. A method, in a macro eNB of a communication system, of assisting a user equipment in a cell range expansion of a pico cell in receiving broadcast information from a pico eNB, wherein a coverage area of the macro eNB comprises at least one region served by the pico eNB, the region served by the pico eNB comprises the cell range expansion, and the macro eNB shares the broadcast information of the pico eNB, and the method comprises:
determining the user equipment which will move from a macro cell into the cell range expansion of the pico cell; and
sending a first assisting signaling to the determined user equipment in a predetermined transmission scheme and a predetermined transmission mode over a predetermined time and frequency resource, the first assisting signaling comprising the broadcast information of the pico eNB shared by the macro eNB and an identifier of the pico cell corresponding to the broadcast information.

2. A method according to claim 1, wherein the determining a further comprises:
determining that the user equipment will move from the macro cell into the cell range expansion of the pico cell upon reception of a sequence number of an event trigger report from the user equipment, wherein the event trigger report indicates that a signal quality of the macro cell is below an absolute threshold, a signal quality of the pico cell plus a biased value is above the signal quality of the macro cell or the signal quality of the pico cell plus the biased value is above an absolute threshold.

3. A method according to claim 1, wherein the determining further comprises:
receiving a predetermined quality parameter from the user equipment, and determining that the user equipment will move from the macro cell into the cell range expansion of the pico cell when the predetermined quality parameter is below a predetermined threshold.

4.-7. (canceled)

8. A method, in a pico eNB of a communication system, of assisting a user equipment in a cell range expansion of a pico cell in receiving broadcast information from the pico eNB, wherein a coverage area of a macro eNB comprises at least one region served by the pico eNB, the region served by the pico eNB comprises the cell range expansion, and the macro eNB shares the broadcast information of the pico eNB, and the method comprises:
sending a first control signaling to the user equipment moving from a macro cell into the cell range expansion of the pico cell, the first control signaling indicating that the pico eNB will send the broadcast information to the user equipment over a time and frequency resource of a protected subframe corresponding to an almost blank subframe of the macro eNB; and
sending the broadcast information over the time and frequency resource of the protected subframe.

9. A method according to claim 8, wherein the time and frequency resource of the protected subframe enables the user equipment to satisfy reception robustness.

10. A method according to claim 8, wherein the sending the broadcast information over the time and frequency resource of the protected subframe further comprises:
updating the user equipment in the cell range expansion and sending the broadcast information to the updated user equipment over the time and frequency resource of the protected subframe.

11. A method, in a user equipment of a communication system, of assisting a user equipment in a cell range expansion of a pico cell in receiving broadcast information from a pico eNB, wherein a coverage area of a macro eNB comprises at least one region served by the pico eNB, the region served by the pico eNB comprises the cell range expansion, and the macro eNB shares the broadcast information of the pico eNB, and the method comprises:
sending a sequence number of an event trigger report or a predetermined quality parameter to the macro eNB;
receiving a first assisting signaling from the macro eNB over a predetermined time and frequency resource, the first assisting signaling comprising the broadcast information of the pico eNB shared by the macro eNB and an identifier of the pico cell corresponding to the broadcast information;
receiving a first control signaling from the pico cell when the user equipment moves from a macro cell into the cell range expansion of the pico cell, the first control signaling indicating that the pico eNB will send the broadcast information to the user equipment over a time and frequency resource of a protected subframe corresponding to an almost blank subframe of the macro eNB; and
receiving the broadcast information from the pico eNB over the time and frequency resource of the protected subframe corresponding to the almost blank subframe of the macro eNB.

12.-14. (canceled)

15. A method, in a pico eNB of a communication system, of assisting a user equipment in a cell range expansion of a pico cell in receiving broadcast information from the pico eNB, wherein a coverage area of a macro eNB comprises at least one region served by the pico eNB, and the region served by the pico eNB comprises the cell range expansion, and the method comprises the stcps of:
determining the user equipment which will move from the pico cell into the cell range expansion of the pico cell;
sending a second assisting signaling to the determined user equipment in a predetermined transmission scheme and a predetermined transmission mode over a time and frequency resource of a protected subframe corresponding to an almost blank subframe of the macro eNB, the second assisting signaling comprising the broadcast information of the pico eNB and an identifier of the pico cell corresponding to the broadcast information;
sending a second control signaling to the user equipment moving from the pico cell to the cell range expansion of the pico cell, the second control signaling indicating that the pico eNB will send the broadcast information to the user equipment over the time and frequency resource of the protected subframe corresponding to the almost blank subframe of the macro eNB; and
sending the broadcast information over the time and frequency resource of the protected subframe.

16. A method according to claim 15, wherein the determining the user equipment which will move from the pico cell into the cell range expansion of the pico cell further comprises:
determining that the user equipment will move from the pico cell into the cell range expansion of the pico cell upon reception of a sequence number of an event trigger report from the user equipment, wherein the event trigger report indicates that a signal quality of the pico cell is below an absolute threshold, a signal quality of a macro cell plus a biased value is above the signal quality of the pico cell or the signal quality of the macro cell plus the biased value is above an absolute threshold.

17. A method according to claim 15, wherein the determining the user equipment which will move from the pico cell into the cell range expansion of the pico cell further comprises:
receiving a predetermined quality parameter from the user equipment, and determining that the user equipment will move from the pico cell into the cell range expansion of the pico cell when the predetermined quality parameter is below a predetermined threshold.

18. (canceled)

19. A method according to claim 15, wherein the time and frequency resource of the protected subframe corresponding to the almost blank subframe of the macro eNB enables the determined user equipment to satisfy reception robustness.

20.-21. (canceled)

22. A method according to claim 15, wherein the sending the broadcast information over the time and frequency resource of the protected subframe further comprises:
updating the user equipment in the cell range expansion and sending the broadcast information to the updated user equipment over the time and frequency resource of the protected subframe.

23. A method, in a user equipment of a communication system, of assisting a user equipment in a cell range expansion of a pico cell in receiving broadcast information from a pico eNB, wherein a coverage area of a macro eNB comprises at least one region served by the pico eNB, and the region served by the pico eNB comprises the cell range expansion, and the method comprises the stcps of:
sending a sequence number of an event trigger report or a predetermined quality parameter to the pico eNB;
receiving a second assisting signaling from the pico eNB over a time and frequency resource of a protected subframe corresponding to an almost blank subframe of the macro eNB, the second assisting signaling comprising the broadcast information of the pico eNB and an identifier of the pico cell corresponding to the broadcast information;
receiving a second control signaling from the pico cell when the user equipment moves from the pico cell into the cell range expansion of the pico cell, the second control signaling indicating that the pico eNB will send the broadcast information to the user equipment over the time and frequency resource of the protected subframe corresponding to the almost blank subframe of the macro eNB; and
receiving the broadcast information from the pico eNB over the time and frequency resource of the protected subframe corresponding to the almost blank subframe of the macro eNB.

24. A method according to claim 23, wherein the event trigger report indicates that a signal quality of the pico cell is below an absolute threshold, a signal quality of a macro cell plus a biased value is above the signal quality of the pico cell or the signal quality of the macro cell plus the biased value is above an absolute threshold.

25. (canceled)

26. A method according to claim 23, wherein the frequency resource of the protected subframe enables the user equipment to satisfy reception robustness.
